(19) United States
(12) Patent Application Publication
(10) Pub. No.: US 2013/0065685 A1
(43) Pub. Date: Mar. 14, 2013

(54) Autobiographical Interface

(71) Applicant: Katrika Woodcock, Issaquah, WA (US)

(72) Inventor: Katrika Woodcock, Issaquah, WA (US)

(73) Assignee: Microsoft Corporation, Redmond, WA (US)

(21) Appl. No.: 13/230,222

(22) Filed: Sep. 12, 2011

(51) Int. Cl. G06F 3/048; A63F 9/24; G06F 15/16

(52) U.S. Cl. 463/36; 715/825

(57) ABSTRACT

This document describes techniques enabling an autobiographical interface. These techniques permit a user to build an interface that represents how the user wishes to be perceived, such as with icons, information, and media selected by the user to represent himself or herself. The techniques permit users to quickly and easily build and alter the autobiographical interface, including to adding new representations or removing out-of-date or undesired representations.

### BACKGROUND

Conventional social-networking websites permit users to present pictures and text about themselves. Unfortunately, these websites often fail to permit users to remove these pictures and text. In some cases these pictures and text simply become stale, and thus don't apply to the user anymore. In some other cases, these pictures and text are misleading or embarrassing. Because users often cannot remove these unwanted pictures and text, users instead present more and more pictures and text to “push down” unwanted information in an attempt to make the information seem less relevant or more difficult to find.

Further still, other people (e.g., “friends”) can presents pictures and text about a user, such as by tagging a user in a picture. In some cases, however, a user may not wish to be represented by that picture. This is increasingly the case as social-networking users learn that their webpage and others' webpages can negatively or inaccurately represent them both in terms of how they are viewed on the Internet and how they are viewed personally.

### SUMMARY

This document describes techniques enabling an autobiographical interface. These techniques permit a user to build an interface that represents how the user wishes to be perceived, such as with icons, information, and media selected by the user to represent himself or herself. The techniques permit users to quickly and easily build and alter the autobiographical interface, including by adding new representations or removing out-of-date or undesired representations. By so doing, the techniques permit users to manage how they are perceived by other people or businesses, which can enable users to receive more-targeted experiences. Further, the autobiographical interface enables others to quickly understand the user, which can help establish friendships and community through shared interests.

This summary is provided to introduce simplified concepts enabling an autobiographical interface, which is further described below in the Detailed Description. This summary is not intended to identify essential features of the claimed subject matter, nor is it intended for use in determining the scope of the claimed subject matter. Techniques and/or apparatuses enabling an autobiographical interface are also referred to herein separately or in conjunction as the “techniques” as permitted by the context.

### BRIEF DESCRIPTION OF THE DRAWINGS

Embodiments enabling an autobiographical interface are described with reference to the following drawings. The same numbers are sometimes used throughout the drawings to reference like features and components:

FIG. 1 illustrates an example system in which techniques enabling an autobiographical interface can be implemented.

FIG. 2 illustrates an example embodiment of the computing device of FIG. 1.

FIG. 3 illustrates an example embodiment of the remote device of FIG. 1.

FIG. 4 illustrates an example method enabling an autobiographical interface.

FIG. 5 illustrates an example user interface having a data entry field enabling entry of text by an individual.

FIG. 6 illustrates the user interface of FIG. 5 along with five selectable representations.

FIG. 7 illustrates an example autobiographical interface having a selected representation of FIG. 6.

FIG. 8 illustrates an example method enabling use and interaction with an autobiographical interface.

FIG. 9 illustrates the example autobiographical interface of FIG. 7 along with a personal-information window and icon information responsive to selection.

FIG. 10 illustrates an example device in which techniques enabling an autobiographical interface can be implemented.

### DETAILED DESCRIPTION

Overview

This document describes techniques enabling an autobiographical interface. These techniques permit a user to build and alter an interface that represents how the user wishes to be perceived. In so doing, users can quickly and easily create a visual representation of themselves. This interface is created and managed by each user, thereby permitting a user to present himself or herself in whatever fashion he or she desires. Thus, instead of being represented by what others may present about a user, such as by friends tagging the user or writing on the user's social-networking webpage, the user presents his or her own, personally selected representations.

Assume, for example, that a user wants to be represented as a great video-game player, an athlete, an offbeat music aficionado, and a Pixel movie fan. He may build his autobiographical interface to show this, such as with an onscreen name “Dragonslayer” and a sword icon, an image of a spaceman from Pixel's Toy Adventure movies, an image of Shaquille O'Neal's basketball shoes, and an album cover of The Muse. These techniques enable this user to quickly and easily build and manage an autobiographical interface displaying these representations. Further still, the techniques permit the user to update and maintain this interface so that it remains up-to-date.

This is but one example of the many ways in which the techniques enable users to build and manage representations of themselves through autobiographical interfaces. Numerous other examples, as well as ways in which the techniques operate, are described below.

This discussion proceeds to describe an example environment in which the techniques may operate, methods performable by the techniques, and an example apparatus below.

Example Environment

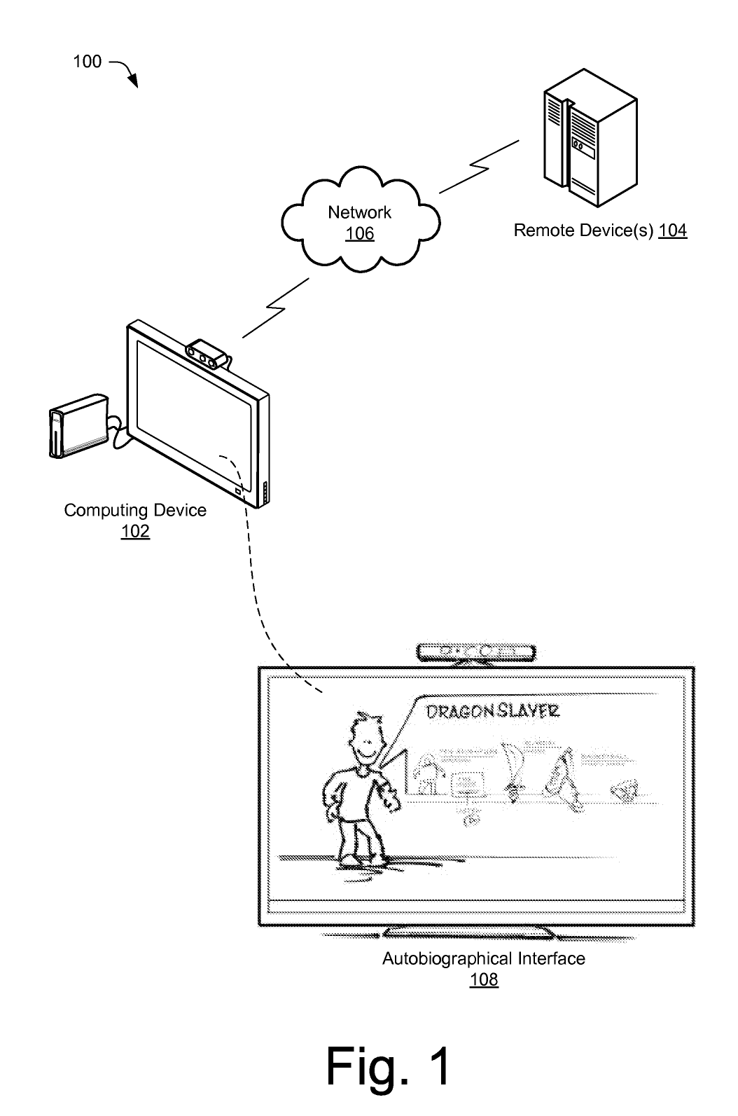

FIG. 1 illustrates an example environment 100 in which techniques enabling an autobiographical interface can be embodied, as well as other operations. Environment 100 includes a computing device 102, remote device(s) 104, network 106, and an example of an autobiographical interface 108. In this illustration, one or more entities operating on computing device 102 and/or remote devices 104 enable a user to build autobiographical interface 108. Aspects of autobiographical interface 108 are described in greater detail following a description of computing device 102 and remote device(s) 104.

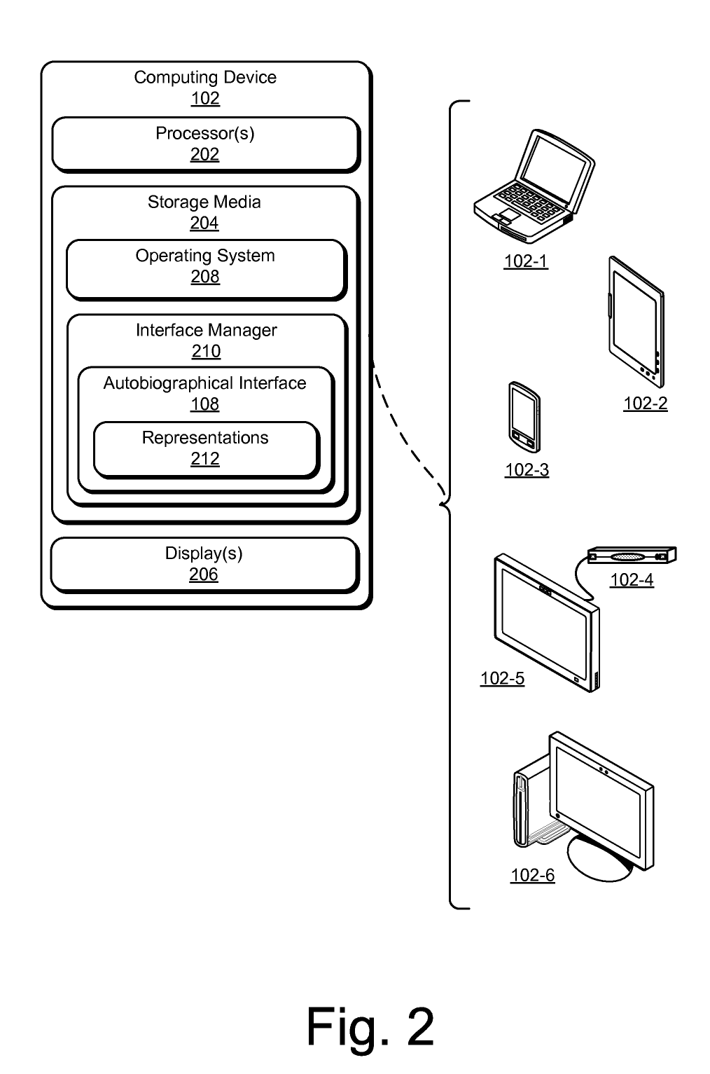

FIG. 2 illustrates an example embodiment of computing device 102 of FIG. 1, which is illustrated with six examples devices: a laptop computer 102-1, a tablet computer 102-2, a smart phone 102-3, a set-top box 102-4, a gaming device 102-5 (with a built-in motion detector for sensing gestures), and a desktop computer 102-6, though other computing devices and systems, such as servers and netbooks, may also be used.

Computing device 102 includes or has access to computer processor(s) 202, computer-readable storage media 204 (storage media 204), and one or more displays 206, five examples of which are illustrated in FIG. 2. Storage media 204 includes an operating system 208 and interface manager 210.

Interface manager 210 includes, has access to, or generates autobiographical interface 108, an example of which is shown in FIG. 1. Interface manager 210 enables use and management of autobiographical interface 108 in various manners described in detail below. In many cases this management includes adding and removing representations 212 to or from autobiographical interface 108. Thus, interface manager 210 enables addition, deletion, and other changes to autobiographical interface 108 through representations 212.

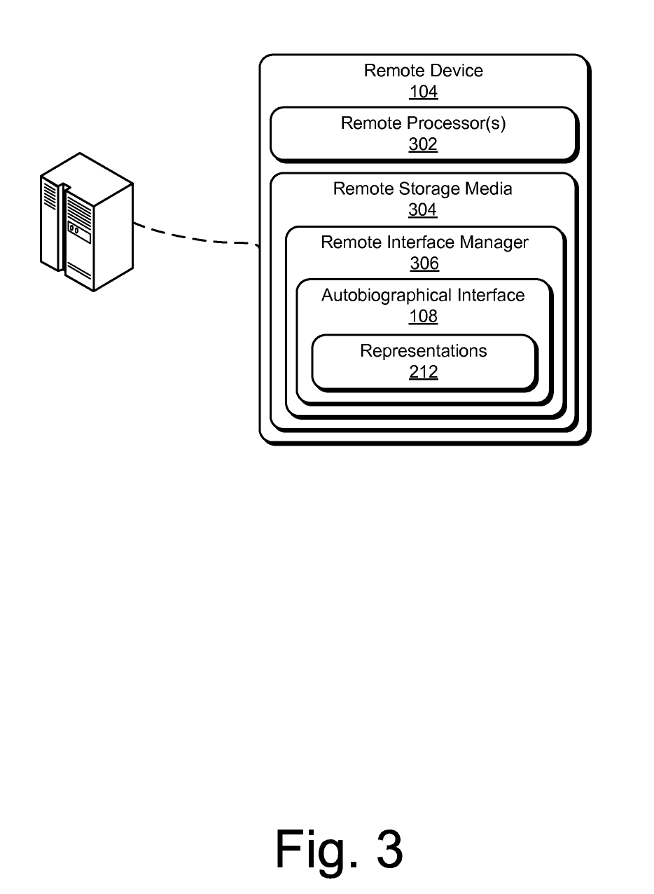

FIG. 3 illustrates an example embodiment of remote device 104. Remote device 104 is shown as a singular entity for visual brevity, though multiple remote devices are also contemplated herein. Remote device 104 includes or has to access to remote processor(s) 302 and remote computer-readable storage media 304 (remote storage media 304). Remote storage media 304 may include a remote interface manager 306 through which a user may interact to build autobiographical interface 108. This remote interface manager 306 may operate in the place of, or in conjunction with, interface manager 210 of FIG. 2. In cases where remote interface manager 306 operates in place of interface manager 210, a web browser or other interface through which a user is enabled to interact with remote interface manager 306 operates on computing device 102. In some embodiments, whether operating separately or in conjunction with interface manager 210 or the web browser on computing device 102, remote interface manager 306 may include or provide representations 212. Thus, in building autobiographical interface 108 on computing device 102, interface manager 210 may receive representations 212 from remote interface manager 306 through network 106.

Ways in which entities of FIGS. 1-3 act and interact are set forth in greater detail below. The entities illustrated for computing device 102 and remote device 104 can be separate or integrated.

Example Methods

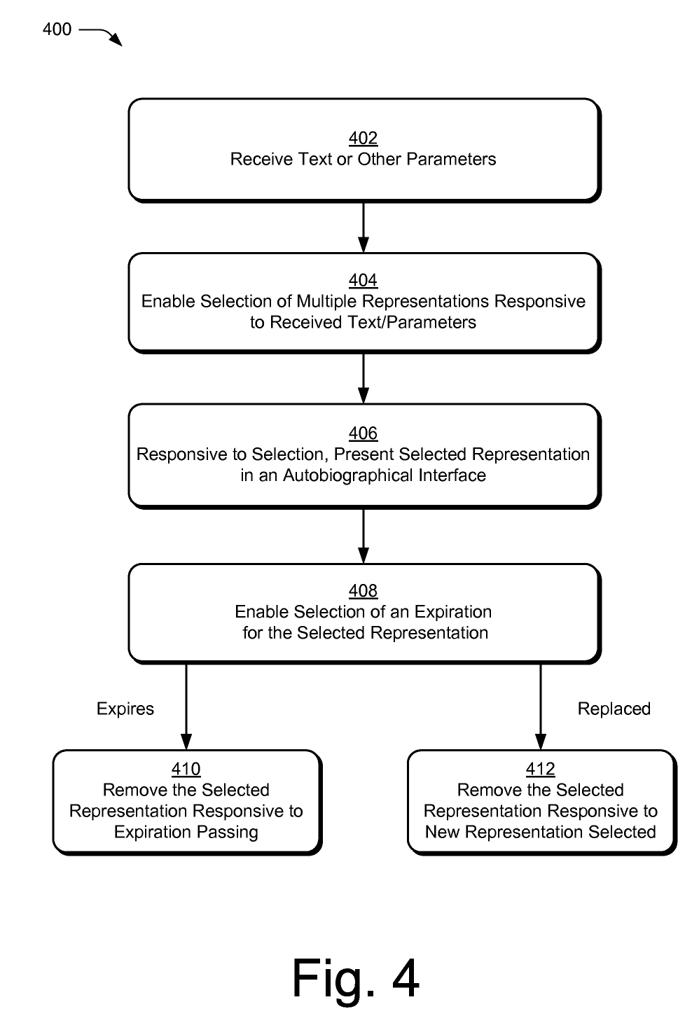

FIG. 4 depicts a method 400 enabling an autobiographical interface. In portions of the following discussion reference may be made to environment 100 of FIG. 1 and as detailed in FIGS. 2 and 3, reference to which is made for example only.

Block 402 receives entry of text or other parameters by which to present multiple representations. The text or other parameters can be received in various manners and from various sources, such as third parties associated with or having information about an individual, the individual wishing to build an autobiographical interface, or internal to the entity performing block 402.

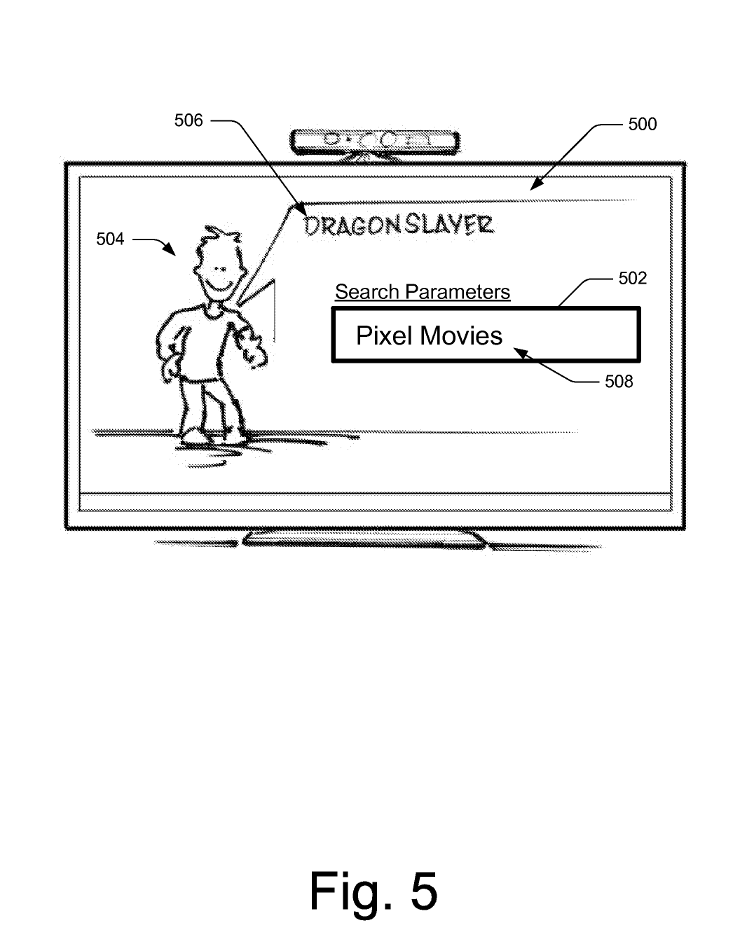

By way of example, consider a case where interface manager 210 of FIG. 2 presents user interface 500 shown in FIG. 5 having a data entry field 502 enabling entry of text by an individual. This example interface is a partially built autobiographical interface having two representations, namely an avatar 504 and name 506 previously chosen by the individual, such as through prior iterations of method 400 or other methods herein. For this example assume that interface manager 210 receives text entered by the individual, namely “Pixel Movies” at received text 508 in FIG. 5.

Block 404 enables selection, responsive to receiving the text or other parameters and/or a search performed based on the text or other parameters, of multiple representations. Representations presented may include an icon, an image, a label, an audio representation (e.g., a song), an audio-visual representation (e.g., a music video), a game (e.g., a video game), or an animated graphic, to name just a few.

Block 404 may act responsive to a search for representations based on received text, or other parameters, or a manual selection. This search can be performed by interface manager 210 or remote interface manager 306. In the ongoing example, interface manager 210 receives text from an individual, namely the text: “Pixel Movies.” In response, interface manager 210 can perform a search or send the text to remote interface manager 306 to perform the search. The search can be manual or automated, such as by a user browsing to a picture or image or of a database of representations, in either case accessible or local to remote device 104 or through network 106 (e.g., the Internet).

Note that the techniques may retain metadata associated with a selected representation, thereby enabling interface manager 210 or remote interface manager 306 to analyze the representation and provide the metadata to users or those viewing the interface. Thus, a user may find a picture of Shaquille O'Neal from his college career that includes metadata, such as associated keywords (e.g., “Shaquille O'Neal,” “Louisiana State University,” and “1991”). The user may select this picture as a representation in autobiographical interface 108, at which point interface manager 210 retains this metadata. This metadata can be used later by interface manager 210 to determine the user's likes, or inform others in response to a hover or other selection of the image, and the like.

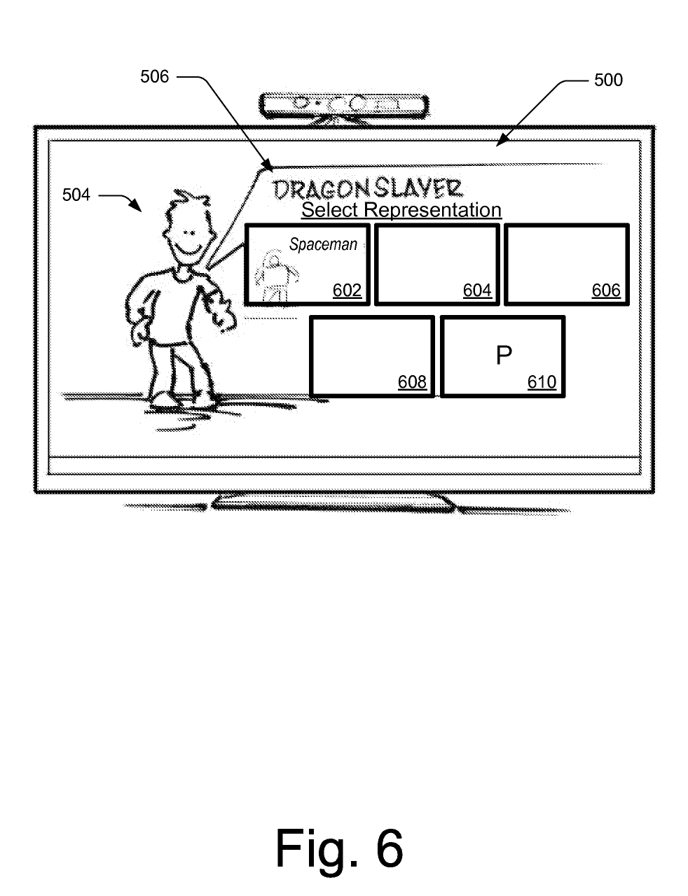

Continuing the ongoing example, consider FIG. 6, which illustrates user interface 500 of FIG. 5 along with five representations: a spaceman character representation 602; a cowboy character representation 604; a short video representation 606; a movie trailer representation 608; and a company icon representation 610. Here interface manager 210 enables selection of one of these representations through a mouse click, handheld game controller, or gesture received through a gesture-sensitive device (e.g., a touch screen or motion-tracking device), though others may be used.

Block 406, responsive to selection of a selected representation of the multiple representations, presents the selected representation in an autobiographical interface. As noted above, the selected representation may be one of many types, such as songs, videos, and games. Thus, on selection of movie trailer representation 608, for example, interface manager 210 may present a visual indicator associated with the movie trailer, such as a title of the movie or a still image from the trailer. While possible to play videos, songs, and games automatically in autobiographical interface 108 of FIG. 1, in the ongoing embodiment the visual indicator is made selectable to cause the trailer to be played, rather than have media be played automatically. Thus, interface manager 210 enables selection of the visual indicator responsive to which interface manager 210 plays the movie trailer, either in a large format (thus expanding past the small size shown in FIG. 6) or in the currently displayed size of the visual indicator.

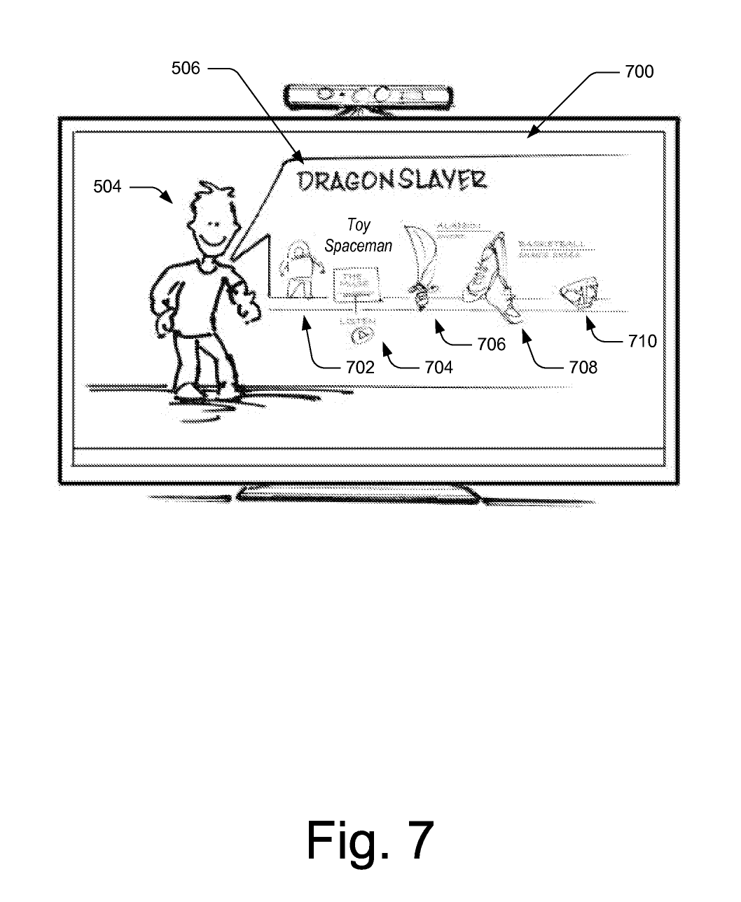

Continuing the ongoing embodiment, assume that interface manager 210 receives selection of spaceman character representation 602. In response, interface manager 210 presents the spaceman image in autobiographical interface 108 as illustrated in FIG. 7 and shown at spaceman character representation 702. Note also that other representations are shown in FIG. 7, here musical group representation 704, a sword icon 706, basketball shoes 708, and dragon fangs 710. Like the movie trailer noted above, these representations 702-710 can be static, animated, and/or selectable. In this example, representations 702-710 are oriented horizontally on a display shelf visually approximating a physical shelf on which people commonly present physical objects representing them, their interests, or their taste or style. Ways in which representations can be interacted with are set forth in greater detail below.

Prior to, commensurate with, or after presenting the selected representation at block 406, block 408 enables selection of an expiration for the selected representation. Interface manager 210, for example, can request that the individual set a time at which the spaceman character representation 702 be removed automatically from autobiographical interface 700. This expiration may also be used to show aging of a representation, order the representations (e.g., from left to right), or set a priority based on which representations are removed when a new representation is added and either no space exists or a limit for representations is reached. Following block 408, method 400 proceeds to block 410 or 412, to block 410 responsive to the expiration passing, to block 412 responsive to the selected representation being replaced.

Block 410, responsive to selection of a selected expiration and the selected expiration passing, removes, from the autobiographical interface, the selected representation. As noted in part above, interface manager 210 may act to keep autobiographical interfaces current and relevant to individuals. Here interface manager 210 does so through expirations, though other manners are also contemplated, including enabling a user to remove and alter representations. Interface manager 210 may also keep autobiographical interfaces relevant and timely by visually aging a representation. This can be shown graphically, such as through fading of a representation, adding spider webs to a representation, or showing a time at which the representation was added or will be removed.

Block 412 removes the selected representation responsive to selection of another representation. In some cases a new representation is selected by an individual and no space or a limit to a number of representations has been met. Interface manager 210, for example, may remove the representation that is set to expire soonest, or ask the individual to select which to remove or which expiration date to extend.

The techniques may also present selectable representations not based on received text or parameters from an individual, as indicated at block 402. In some embodiments, the techniques determine, based on information about the individual associated with the autobiographical interface, representations related to the individual. This information can come from various sources, such as remote third parties or applications on computing device 102. For example, a word processing application may indicate to interface manager 210 that the individual spends over 1,500 hours a year using the word processing application. Responsive to this information, interface manager 210 may suggest adding a representation to the individual's autobiographical interface. This representation could indicate that the individual is an expert word-processing user.

Further, interface manager 210 may verify this and other representations, such as through certifications from entities or third parties (e.g., from the user's own applications). Thus, interface manager 210 may receive a verification that the individual is an “expert” word-processing user. As another example, assume that sword representation 706 is associated with a video game called “Aladdin.” Not only can the sword indicate that the individual likes the game, but also the individual's proficiency. The game Aladdin, for example, can verify that the individual is a world-class player, or is one of only 100 people that have won the game, and the like. The sword representation may itself indicate this proficiency, as only true experts are permitted to use this representation (this can be shown with a verification indicator or icon). With these representations, another advanced Aladdin player may contact the individual to discuss the game or compete. The individual, however, may select or deselect this verification from being presented. The individual may not wish others to know that he spends that much time playing video games or working on word processing applications.

By way of yet another example, assume that interface manager 210 receives, from a job-based social-networking website, information indicating that the individual went to college at Duke University. In response, interface manager 210 can present various selectable representations, such as a Duke Mascot icon, Duke Basketball image, video from Duke winning a national NCAA basketball title, or the individual's degree itself. Interface manager 210 may also verify these representations, such as by showing that the Duke Registrar Office has certified that the individual did go to Duke and did receive the degree shown in the autobiographical interface.

While the above method is described in the context of a single autobiographical interface for a single user, interface manager 210 may present more than one autobiographical interface 108 or facets thereof, each covering a persona of the user, such as a professional interface, a friends' interface, a family interface, a gaming interface, and so forth.

Having described some ways in which the techniques enable individuals to build and manage an autobiographical interface, the description proceeds to describe some ways in which the techniques enable interactions with an autobiographical interface, including by other individuals.

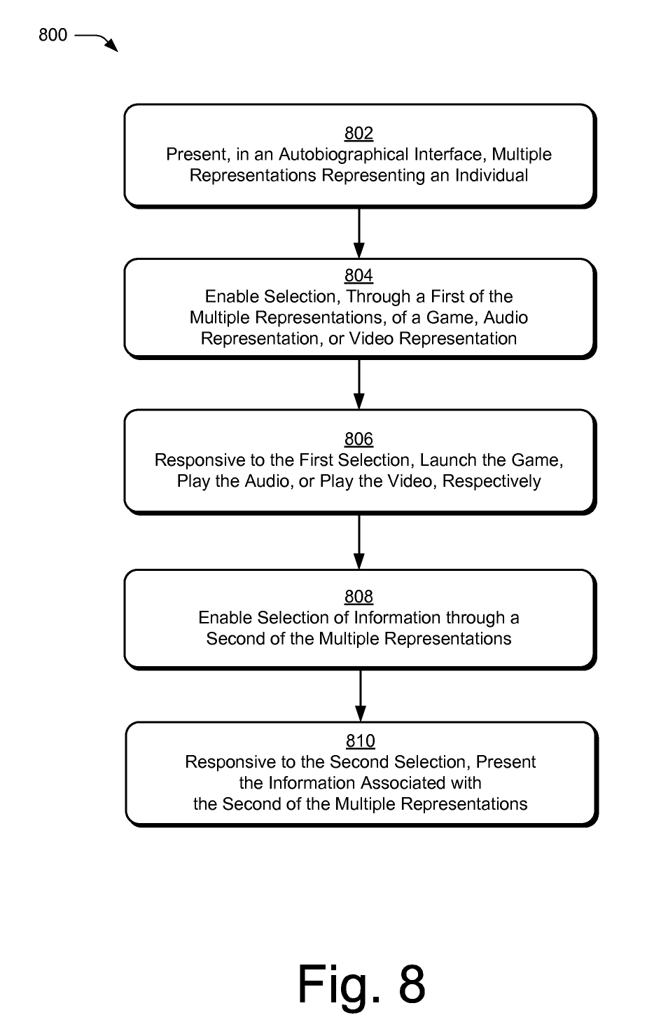

FIG. 8 depicts a method 800 enabling use and interaction with an autobiographical interface. In portions of the following discussion reference may be made to environment 100 of FIG. 1 and as detailed in FIGS. 2 and 3 as well as method 400, reference to which is made for example only.

Block 802 presents, in an autobiographical interface, multiple representations representing an individual. By way of example, consider again FIG. 7 in which autobiographical interface 702 presents seven representations, 504, 506, 702, 704, 706, 708, and 710.

Block 804 enables a first selection, through a first of the multiple representations, of a game, an audio representation, or a video representation. Enabling selection as part of this method can be performed through various manners, such as through a touch or motion gesture, a mouse click, hot keys, a mouse hover over the representation. Continuing the example of FIG. 7, interface manager 210 presents and enables selection of one or more of the representations.

Block 806, responsive to the first selection of the first of the multiple representations, launches the game, plays the audio, or plays the video. To do so, interface manager 210 may use browser functionality, an applet, a media player, or some application capable of rendering audio. Interface manager 210 can launch the game or play the audio or video through autobiographical interface 700 or otherwise.

Assume here than an individual visiting the autobiographical interface of the individual named “Dragonslayer” selects to listen to the musical group through selection of representation 704 of FIG. 7. Here interface manager 210 begins playing audio associated with representation 704, such as a first song of the album. Thus, interface manager 210 may play a video through interface 700 or by presenting another application to do so.

Block 808 enables a second selection, through a second of the multiple representations, of information associated with one or more of the multiple representations. This selection is enabled in any one of the above-noted manners, such as a mouse hover over one of representations 504, 506, 702, 704, 706, 708, or 710 of FIG. 7.

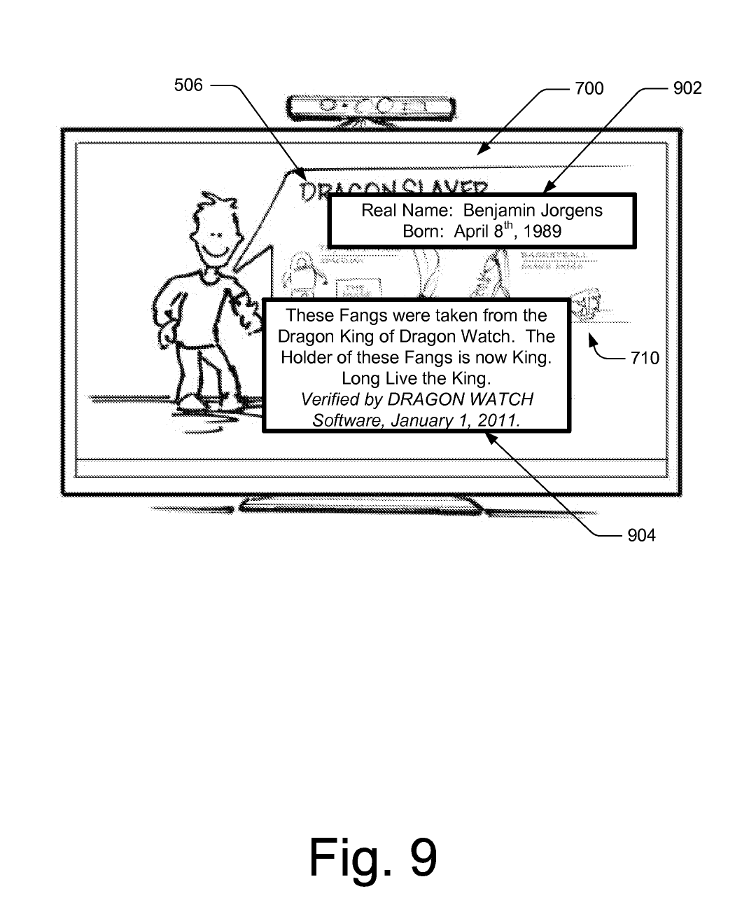

Block 810, responsive to the second selection, presents the information associated with the second of the multiple representations. Assume here that another individual visits autobiographical interface 700 and wishes to know more about the individual associated with interface 700. To learn this information, the other individual hovers a mouse over name representation 506 of FIG. 7. In response, interface manager 210 presents information, shown at personal information window 902 in FIG. 9. By way of further example, assume that the other individual wants to know more about the fangs of representation 710. Responsive to selection, interface manager 210 presents the information at icon information 904. This information indicates that the individual named Dragonslayer has won the Dragon Watch game. Further, the information includes a third-party verification of this fact by the maker of the game.

The preceding discussion describes methods enabling an autobiographical interface as well as other methods. These methods are shown as sets of blocks that specify operations performed but are not necessarily limited to the order shown for performing the operations by the respective blocks.

Aspects of these methods may be implemented in hardware (e.g., fixed logic circuitry), firmware, a System-on-Chip (SoC), software, manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable memory devices, both local and/or remote to a computer processor. The methods may also be practiced in a distributed computing environment by multiple computing devices.

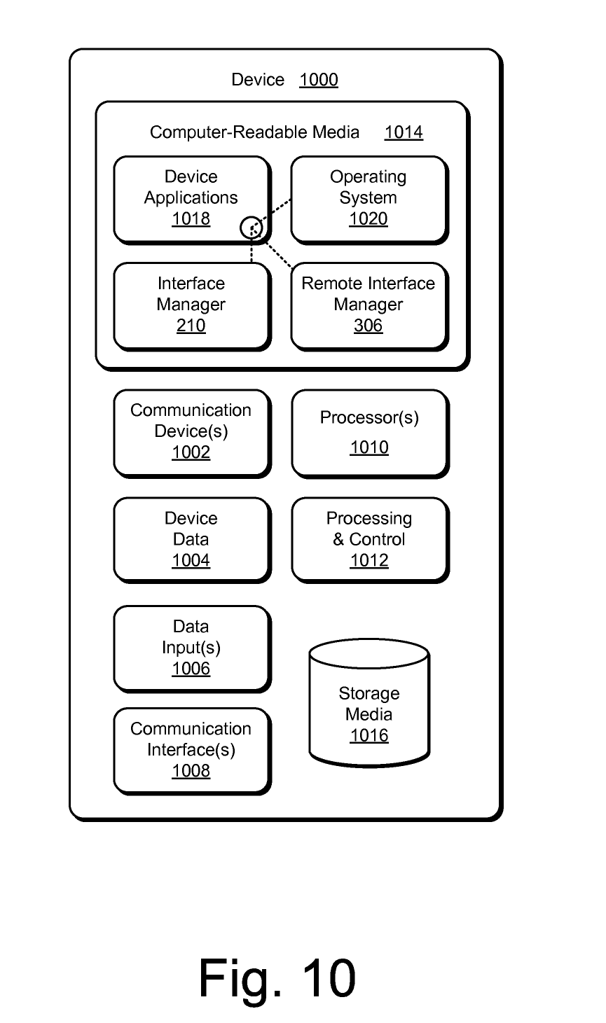

These techniques may be embodied on one or more of the entities shown in environment 100 of FIG. 1 (and as detailed in FIGS. 2 and 3) and/or example device 1000 described below, which may be further divided, combined, and so on. Thus, environment 100 and/or device 1000 illustrate some of many possible systems or apparatuses capable of employing the described techniques. The entities of environment 100 and/or device 1000 generally represent software, firmware, hardware, whole devices or networks, or a combination thereof. In the case of a software implementation, for instance, the entities (e.g., interface manager 210 of FIG. 2 or remote interface manager 306 of FIG. 3) represent program code that performs specified tasks when executed on a processor (e.g., processor(s) 202 and 302, respectively). The program code can be stored in one or more computer-readable memory devices, such as computer-readable storage media 204 or 304 or computer-readable storage media 1014 of FIG. 10. The features and techniques described herein are platform-independent, meaning that they may be implemented on a variety of commercial computing platforms having a variety of processors.

Example Apparatus

FIG. 10 illustrates an apparatus having various components, here as part of, or containing, an example device 1000, which can be implemented as any type of client, server, and/or computing device as described with reference to the previous FIGS. 1-9 to implement techniques enabling an autobiographical interface. In embodiments, device 1000 can be implemented as one or a combination of a wired and/or wireless device, as a form of television client device (e.g., television set-top box, digital video recorder (DVR), etc.), consumer device, computer device, server device, portable computer device, user device, communication device, video processing and/or rendering device, appliance device, gaming device, electronic device, and/or as another type of device. Device 1000 may also be associated with a user (e.g., an individual) and/or an entity that operates the device such that a device describes logical devices that include users, software, firmware, and/or a combination of devices.

Device 1000 includes communication devices 1002 that enable wired and/or wireless communication of device data 1004 (e.g., received data, data that is being received, data scheduled for broadcast, data packets of the data, etc.). The device data 1004 or other device content can include configuration settings of the device, media content stored on the device, and/or information associated with a user of the device. Media content stored on device 1000 can include any type of audio, video, and/or image data. Device 1000 includes one or more data inputs 1006 via which any type of data, media content, and/or inputs can be received, such as user-selectable inputs, messages, music, television media content, recorded video content, and any other type of audio, video, and/or image data received from any content and/or data source.

Device 1000 also includes communication interfaces 1008, which can be implemented as any one or more of a serial and/or parallel interface, a wireless interface, any type of network interface, a modem, and as any other type of communication interface. The communication interfaces 1008 provide a connection and/or communication links between device 1000 and a communication network by which other electronic, computing, and communication devices communicate data with device 1000.

Device 1000 includes one or more processors 1010 (e.g., any of microprocessors, controllers, and the like), which process various computer-executable instructions to control the operation of device 1000 and to implement techniques enabling an autobiographical interface. Alternatively or in addition, device 1000 can be implemented with any one or combination of hardware, firmware, or fixed logic circuitry that is implemented in connection with processing and control circuits which are generally identified at 1012. Although not shown, device 1000 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1000 also includes computer-readable storage media 1014, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 1000 can also include a mass storage media device 1016.

Computer-readable storage media 1014 provides data storage mechanisms to store the device data 1004, as well as various device applications 1018 and any other types of information and/or data related to operational aspects of device 1000. For example, an operating system 1020 can be maintained as a computer application with the computer-readable storage media 1014 and executed on processors 1010. The device applications 1018 may include a device manager, such as any form of a control application, software application, signal-processing and control module, code that is native to a particular device, a hardware abstraction layer for a particular device, and so on.

The device applications 1018 also include any system components or modules to implement techniques enabling an autobiographical interface. In this example, the device applications 1018 can include interface manager 210 and/or remote interface manager 306.

### CONCLUSION

Although embodiments of techniques and apparatuses enabling an autobiographical interface have been described in language specific to features and/or methods, it is to be understood that the subject of the appended claims is not necessarily limited to the specific features or methods described. Rather, the specific features and methods are disclosed as example implementations enabling an autobiographical interface.

What is claimed is:

1. A computer-implemented method comprising:
receiving entry of text;
enabling selection, responsive to receiving entry of the text and a search performed based on the text, of multiple representations found with the search performed based on the text;
responsive to selection of a selected representation of the multiple representations, presenting the selected representation in an autobiographical interface;
enabling selection of an expiration; and
responsive to selection of a selected expiration and the selected expiration passing, removing, from the autobiographical interface, the selected representation.

2. A computer-implemented method as described in claim 1, further comprising presenting a data-entry field and wherein receiving entry of text is received through the data-entry field.

3. A computer-implemented method as described in claim 2, wherein presenting the data-entry field is performed through the autobiographical interface.

4. A computer-implemented method as described in claim 1, further comprising performing the search based on the text and responsive to receiving entry of the text.

5. A computer-implemented method as described in claim 1, further comprising:
providing the text to a remote device over a communication network; and
responsive to providing the text, receiving the multiple representations from the remote device and over the communication network.

6. A computer-implemented method as described in claim 1, wherein the multiple representations include an icon, an image, a label, an audio representation, an audio-visual representation, a game, or an animated graphic.

7. A computer-implemented method as described in claim 1, wherein the selected representation includes an audio representation, an audio-visual representation, or a game, and presenting the selected representation presents a visual indicator associated with the audio representation, the video representation, or the game, and further comprising:
enabling selection, through the visual indicator from within the autobiographical interface, of the audio representation, the audio-visual representation, or the game; and
responsive to selection of the visual indicator of the audio representation, the audio-visual representation, or the game, playing audio of the audio representation, playing audio and moving visuals of the visual representation, or enabling play of the game, respectively.

8. A computer-implemented method as described in claim 1, further comprising, prior to removing the selected representation, visually indicating an age or aging of the selected representation.

9. A computer-implemented method as described in claim 1, further comprising:
determining, based on information about an individual associated with the autobiographical interface, other representations related to the individual;
presenting the other representations through the autobiographical interface;
enabling selection of the other representations; and
responsive to selection of a selected other representation of the other representations, presenting the selected other representation in the autobiographical interface.

10. A computer-implemented method as described in claim 1, wherein the autobiographical interface includes one or more existing representations previously selected to represent an individual associated with the autobiographical interface and further comprising:
removing one of the one or more existing representations responsive to the selection of the selected representation.

11. A computer-implemented method as described in claim 1, further comprising indicating a third-party verification for the selected representation.

12. A computer-implemented method comprising:
presenting, in an autobiographical interface, multiple representations representing an individual;
enabling a first selection, through a first of the multiple representations, of a game, an audio representation, or an audio-visual representation;
responsive to the first selection of the first of the multiple representations, launching an associated game, playing associated audio, or playing associated video, respectively;
enabling a second selection, through a second of the multiple representations, of information associated with the second of the multiple representations; and
responsive to the second selection, presenting the information associated with the second of the multiple representations.

13. A computer-implemented method as described in claim 12, wherein enabling a first selection or enabling a second selection is enabled through a gesture received through a gesture-sensitive display on which the autobiographical interface is displayed.

14. A computer-implemented method as described in claim 12, wherein enabling a first selection or enabling a second selection is enabled through a hover over the first of the multiple representations or the second of the multiple representations, respectively.

15. A computer-implemented method as described in claim 12, wherein playing associated audio or associated video is performed in the autobiographical interface.

16. A computer-implemented method as described in claim 12, wherein the information includes a third-party verification of the second of the multiple representations.

17. A computer-implemented method as described in claim 12, wherein the information presents additional information about the second of the multiple representations, an association between the second of the multiple representations and the individual, or about the individual.

18. A computer-implemented method as described in claim 12, wherein the autobiographical interface includes a display shelf, and wherein presenting multiple representations representing an individual presents the multiple representations on the display shelf.

19. A computer-implemented method comprising:
presenting, in an autobiographical interface, multiple existing representations representing an individual;
enabling selection of one of multiple new representations responsive to receiving parameters and preforming a search for the multiple new representations based on the received parameters;
responsive to selection of a selected new representation of the new representations, removing one of the multiple existing representations and presenting the selected new representation;
enabling selection, through the new representation or a remaining of the multiple existing representations, of information associated with, or play of media associated with, the new representation or the remaining of the multiple existing representations; and
responsive to the selection, presenting the information or playing the media within the autobiographical interface.

20. A computer-implemented method as described in claim 19, wherein removing one of the multiple existing representations removes an oldest of the multiple existing representations or a soonest-to-expire of the multiple existing representations.
